(19) United States
(12) Patent Application Publication
(10) Pub. No.: US 2003/0222765 A1
(43) Pub. Date: Dec. 4, 2003

(54) Method and system for alerting a user to time-related communication

(76) Inventors: David Curbow, Sunnyvale, CA (US); Vicky L. Oliver, Mountain View, CA (US); Nigel Simpson, Bainbridge Island, WA (US)

Correspondence Address: WAGNER, MURABITO & HAO LLP, Third Floor, Two North Market Street, San Jose, CA, 95113, US

(21) Appl. No.: 10/157,438

(22) Filed: May 28, 2002

(51) Int. Cl. G08B 1/00

(52) U.S. Cl. 340/309.7; 709/217; 379/93.24

(57) ABSTRACT

Embodiments of the present invention relate to a method and system for automatically alerting a user to electronic communication, such as an email message, that is related to a scheduled event such as an upcoming meeting. The method includes automatically scanning a user's calendar for a scheduled event, scanning the user's electronic inbox to find email messages related to the scheduled event, determining if the user requires notification of the incoming email and notifying the user of the incoming email by appropriate mechanisms. The method is enabled to determine the urgency of the email and its relative importance to the user by subjecting the email to a set of user-selected rules. These rules can be based on time constraints, relative importance of the scheduled event, or virtually any other criteria that can be assessed by reference to the subject header, body, or sender of the message.

### FIELD OF THE INVENTION

Embodiments of the present invention relate to the field of electronic messaging, e.g., electronic mail, and computer communication management.

### BACKGROUND OF THE INVENTION

The typical modern workplace is heavily computerized, with communication, scheduling, and work output all now either primarily or entirely computer based. Much of the formerly paper intra-office communication can be performed using electronic “email”.

A problem experienced with email in a corporate environment is the huge volume of messages that accumulate in a user's inbox in a short period of time. Some industry researchers estimate that there are an average of 2500 messages per user inbox at any time. Such volume overwhelms users attempting to manage those messages.

Email is often used to distribute information about meetings, including background information, pre-work, pre-reading, and other things, that may require the user to take some time to prepare. However, these emails may remain unread because the user fails to find the important messages in time. Manually scanning messages one-by-one in a busy inbox may not guarantee that the user will find messages related to upcoming meetings in time to make use of the information.

### SUMMARY OF THE INVENTION

A need exists, therefore, for an automated means by which the recipient of electronic messages relating to an upcoming event can be notified of the messages' existence before the event to which they relate transpires. The method should also be able to determine a relative urgency and importance of the incoming messages by reference to a set of rules the user can define and should indicate the relative urgency to the recipient.

Disclosed herein is a method and system for automatically notifying a recipient of incoming electronic messages relating to an upcoming event before the event to which they relate transpires. The method can also determine a relative urgency and importance of incoming messages by reference to a set of rules the user can define and can indicate the relative urgency to the recipient.

Some example relationships between appointments and email are recognized by the present invention. For instance, often the person who has called the meeting, (listed as the “owner”, or “proposer” or similar term) sends email to the group of people that have been invited to the meeting. To make it easier for the invitees to recognize that the email relates to the meeting, its title may use the same or similar title as was used for the meeting title, which may include a meeting subject, conference room name, project identification, case name, account name, etc. Other meeting invitees may also follow this convention, and their messages will use the same or similar title when sending their messages relating to the meeting.

Embodiments of the present invention relate to a method and system for automatically alerting a user to electronic communication, such as an email message, that is related to a scheduled event such as an upcoming meeting. The method includes automatically scanning a user's calendar for a scheduled event, scanning the user's electronic inbox to find email messages related to the scheduled event, determining if the user requires notification of the incoming message and notifying the user of the incoming message by means of the user's preferred mechanism. The method is able to determine the urgency of the message and its relative importance to the user by subjecting the message to a set of user-selected rules. These rules can be based on time constraints, relative importance of the scheduled event, or virtually any other criteria that can be assessed by reference to the information of the electronic message, e.g., the subject header, body, or sender of the message.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The operation and components of this invention can be best visualized by reference to the drawings.

FIG. 1 illustrates a flow diagram of a computer implemented method in accordance with one embodiment of the present invention.

FIG. 2 illustrates an exemplary computer network in accordance with one embodiment of the present invention.

FIG. 3 illustrates a generic computer such as would be used in accordance with one embodiment of the present invention.

FIG. 4 illustrates a data flow diagram between software modules of one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, and components have not been described in detail so as not to unnecessarily obscure aspects of the present invention. At times, concepts disclosed in this discussion of embodiments of the present invention will be made more readily apparent be reference to the Figures.

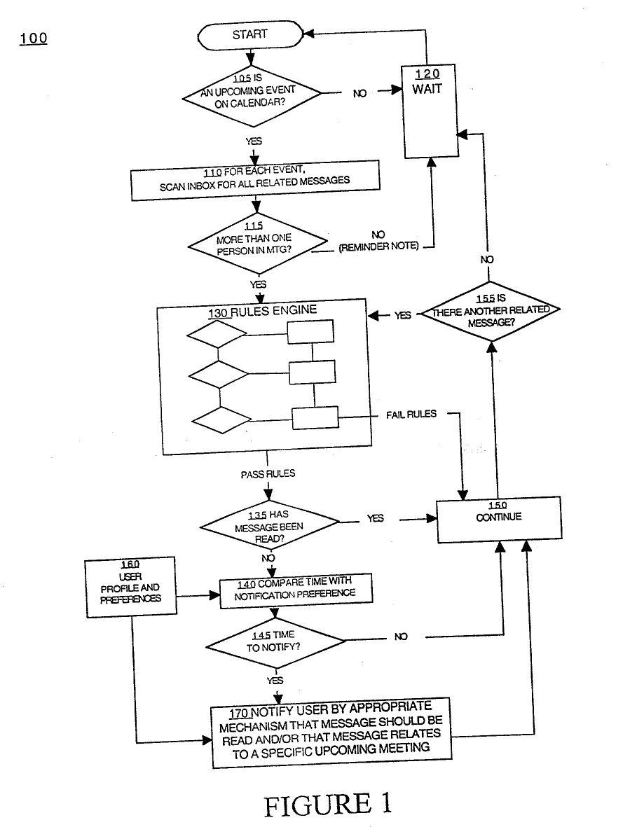

FIG. 1 illustrates one embodiment of the present invention in flow diagram form. There, computer implemented process 100 starts with an automated scan of the user's computer calendar application, and a determination if there is a scheduled event, at 105. Any of a number of well known calendar programs can be used by the present invention. If there is no scheduled event, the process 100 enters a wait state, 120, before starting anew. If an upcoming event is present in the user's calendar application or database, the event is noted and the user's email inbox is scanned for references to the upcoming event, 110. When a message is found that refers to the scheduled event, e.g., meeting, a set of queries are asked about the message. At 115, a meeting invitee list from the calendar is queried to determine if the number of meeting attendees exceeds one. This query can determine if the user has left a “self-reminder” message in the inbox. If the number of attendees does not exceed one, the process 100 enters the wait state prior to recommencing its automated scan. If more than one person is to be in the meeting, the unread message is subjected to a set of rules 130 that the user has previously selected.

The rules included in the user's pre-selected rules set or preferences can include virtually any criteria that can be measured by the contents of the electronic message, e.g., the message body, its subject header, or its sender. These preferences can be stored on a disk or any other storage medium. Some examples are: the meeting time compared to the present time; whether the user is conducting the meeting or is merely an attendee; or whether the meeting is ranked high or low by the user in a calendar prioritization. Virtually any other rule query can be used and other examples are discussed subsequently in the Rules Engine section.

If the message fails to meet the rule-based criteria, the process 100 continues at 150 and determines if there is another message related to the meeting in the inbox, 155. If not, the process returns to the wait state, 120. If another related message exists, it is subjected to the rules engine query as before.

When a message passes the rule-based queries, a determination is made as to whether the message has been read, 135. If it has already been read, then the process 100 again seeks a new message at 150 and 155. If the message has not been read, the user's preferences, 160, are read to determine both the proper time to alert the user as well as the user's preferred method of notification, 140. When it is time to notify the user, 145, the user is notified by the proper medium at 170 and, if there are no more messages, 155, the process 100 returns to the wait state, 120, ready to begin anew.

User notification may take place using a number of different mechanisms. For instance, the user may be notified by changing a visual attribute associated with the email message to show a higher priority. Alternatively, a display alert dialog may also appear on the user's desktop or laptop screen. A message can also be sent to the user's pager or cellular phone, etc.

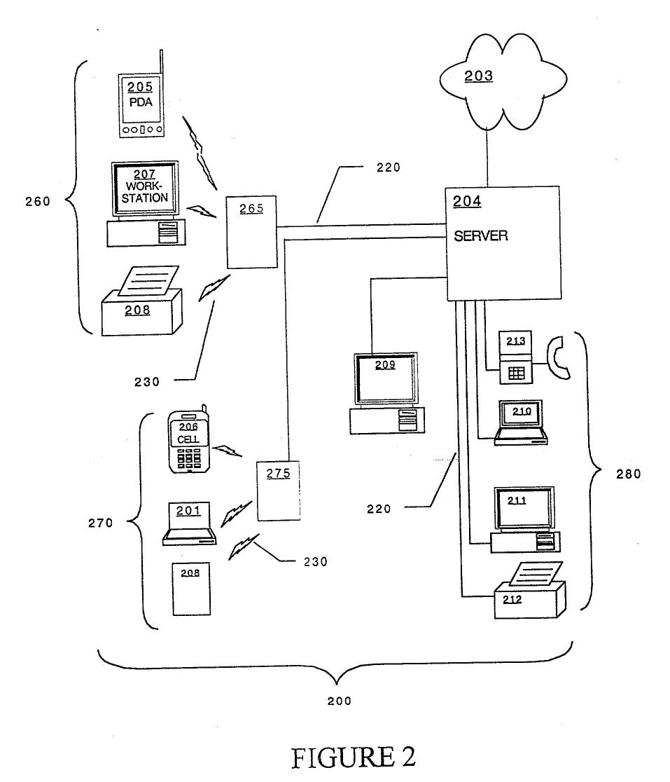

FIG. 2 is an illustration of an exemplary computer network that can be used in this embodiment of the present invention. Exemplary network 200 includes server system 204 connected by data lines 220 to work centers 260, 270 and 280, as well as computer 209. The computers and peripherals that can make up work center 280, computer 211, laptop 210, printer 212 and voice over internet protocol (VOIP) telephone 213, may be connected by individual data lines 220 to server system 204. Wireless personal area network (PAN) work centers 260 and 270 may be in wireless communication, 230, with PAN hubs 265 and 275, respectively. Work center 260 may include work station 207, printer 208 and wireless-enabled personal data assistant (PDA) 205.

Work center 270 may include laptop computer 201, cellular phone 206 and pager 208. Cellphone 206 is, in this example, enabled to communicate with the network via wireless hub 275, as is pager 208. In FIG. 2, network 200 is also shown linked to Internet 203 by server 204. Note that the arrangement and numbers of computers, peripherals, and connections shown in this example are only for illustrative purposes. This embodiment of the present invention is not dependent on the precise compliment of the network on which it operates.

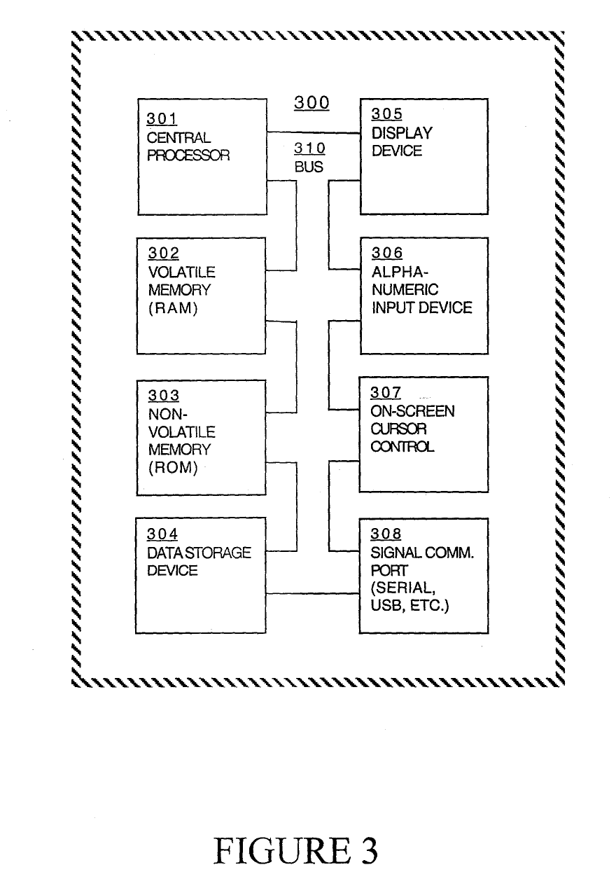

The embodiment of the present invention discussed here may be implemented as software programming code used by a computer similar to the generic computer illustrated in FIG. 3, in block diagram. There, computer system 300, e.g., server system 204, system 211, 210, 201, 207, etc., comprises bus 310 which electronically connects central processor 301, volatile RAM 302, non-volatile ROM 303 and data storage device 304. Optional display device 305 is also connected to the bus. Similarly connected are optional alpha-numeric input device 306, optional cursor control 307, and signal I/O device 308. Signal I/O device 308 could be implemented as a serial connection, USB, an infrared transceiver or an RF transceiver. In this embodiment of the present invention, device 308 is utilized to provide connection with a network and is, therefore, part of the path of electronic communication in the network. Generic computer 300 is illustrative of many of the devices found in exemplary network 200, shown in FIG. 2, such as work station 207 and server 204, among others.

Many of the devices illustrated in the exemplary network illustrated in FIG. 2 are enabled to communicate via the network 200 using email. In a large modern workplace, the volume of email between users of the local network and of the Internet is extremely large. The embodiments of the present invention are useful in allowing users to manage and discover priority mail messages.

Most users in the network 200 have electronic calendar applications that keep track of the user's project milestones and deadlines and of the meetings that inevitably accompany communications between large numbers of people. Electronic calendars, like email, are enabled by the computers and the network to which they are connected. In some cases, calendar applications and calendar databases are resident in a server, such as 204 in FIG. 2. In such cases, the calendar can be coordinated for all users.

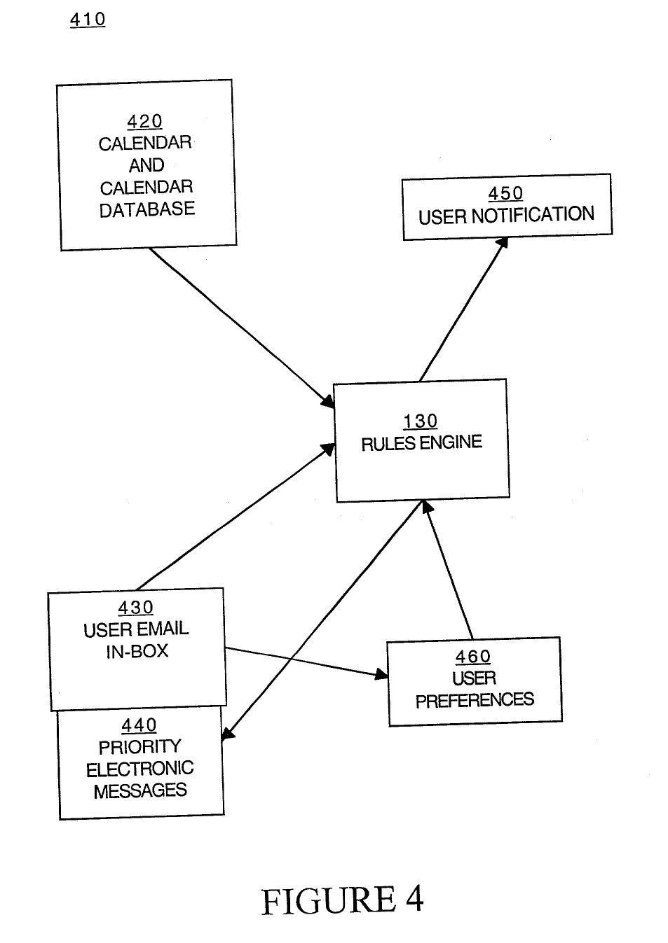

As shown in FIG. 4, the calendar and calendar database 420 interfaces with rules engine 130 so that the engine 130 can obtain scheduling information regarding scheduled meetings in a timely manner. The rules engine 130 operates according to flow 100 described above. User preferences 460 impact the checks performed by the rules engine 130 for locating emails within the user's in-box 430. Priority emails 440 can be singled out and highlighted in accordance with the present invention. Priority emails are those that relate to scheduled events as detected by the rules engine 130. User notification 450 may also take the form of changing the message priority to high or highest priority, or take the form of alerts such as dialog reminders, or pager messages, etc.

In addition to the client notification techniques discussed above, notification 450 can also originate from the calendar application 420. For instance, calendar clients, sometimes different from email clients, may display a dialog reminder for the user of an upcoming meeting. These dialogs could also point out that there are messages relating to the meeting that have yet to be read.

This embodiment of the present invention uses information from the user's calendar 420 and email inbox 430, applies some rules 130 that describe frequently occurring relationships between meetings, events or appointments, and email. It is thus able to inform the user, 450 or 440, that there are messages relating to an upcoming calendared meeting or appointment that he or she should read.

One example of a relationship between appointments and email that can be assessed by an automatic method is shown here. Often the person who has called a meeting, possibly listed as the “owner” or “proposer” or similar term, will send a common email message to the group of users that have been invited to the meeting. To make it easier for invitees to recognize that the email message relates to the meeting, its title will use the same or a similar title or subject when sending electronic messages relating to the meeting.

Rules that can be applied to information gleaned from a user's email inbox 430 and from the calendar server 420 can be applied through a Rules Engine 130 as was shown in FIG. 4 at 130. Users are allowed, in this embodiment of the present invention, to set preferences 460 for how they want email filtered and can further assign linkages, such as Boolean operators, to rules and rule priorities.

Some example rules are: 1, The message recipients list of the email matches the list of meeting attendees from the calendar; 2, The message sender matches the meeting owner; 3, The message recipients/sender list contains at least the name of the meeting owner; 4, The message subject contains keywords defined by the calendar server, such as “event reminder” or “event notification”; 5, The message body contains keywords in defined locations: “ummary” begins a line followed by “start:” on the next line and “end:” on the line after that; and/or, An attached calendar object contains the same content, such as done time, unique I.D. or people or meeting attendees listed.

When one or more of these rules are satisfied, the rules engine then identifies the corresponding message and can inform the user by some available notification mechanism. The indication can also include a relationship between the relevant meeting or scheduled event. It is appreciated that rules are programmable by the user and new rules can be added.

The user is allowed to select from the above rules, or others that the user may develop, for personal preferences 460. For example, a user may chose to ignore one rule while employing the others. Users are also allowed to specify the linkages between individual rules so that, for example, if Rule 2 AND Rule 4 result in a “True”, an immediate notification can be sent.

A user can also specify that if a particular rule is true then the notification that is generated can be of a high priority, medium priority, etc. For example, if Rule 4 is true, then a high-priority notification can be generated. However, with the linkages illustrated above, if Rule 4 is true but Rule 5 is false, then a low priority notification can be generated.

The user receiving these messages may need differing amounts of time to process different messages. For example, short email messages may require only a minute or two to read, while longer messages, or messages with attachments or links will typically require more time. This embodiment of the present invention allows some users who prefer the lead time to print out messages longer than a page or two and read them offline. Some users may want to be notified only when they are reading email while others will want to be notified in other ways. Recognizing these user behaviors, and others, customized rules can be added to the rules engine 130 that examine the user's inbox 430 and calendar 420 and precipitate notification according to the user's individual preferences 460 and needs.

Processing these rules can take place on a work center computer, such as a desktop or laptop, or on a server. On a desktop or laptop this functionality might be integrated into a commercially available email/calendar client as well as being implemented in proprietary software.

One embodiment of the present invention may also be implemented in a server. Users often do not have their desktop or laptop systems running continually. If this embodiment were implemented in the work center computer, the automated email/calendar checker may not be in operation when important messages are sent, so the user may not be notified within the time preference set. Some important email messages could be missed in this case. In contrast, servers are typically in continuous operation so there is a smaller chance that missed messages will occur.

It is also possible that important messages may arrive when the user is away from the work center, perhaps in a different meeting. Users can then miss the notification of an approaching meeting and thus the need to read associated email messages. Accordingly, the automated method employed in this embodiment of the present invention can make use of multiple mechanisms 430 and 460 to notify the user. These multiple mechanisms include client software on desktop or laptop systems, users' pagers, text messages to the user's appropriately enabled phone or cellphone, or using a text-to-speech device to deliver a voice message, as well as numerous other means. As a result, the user is more likely to be notified in time to read the message before the meeting or other event.

After a message has been identified as being relevant to an upcoming meeting, this embodiment of the present invention notifies, 450, the recipient of the email. Note that the particular means for reading user preferences for notification chosen for any embodiment is immaterial to the concepts presented in this discussion. Any appropriate means may be employed.

Moreover, the notification message can include priority codes or flags. Since priority can change, as discussed previously, a means is incorporated to flag the user more urgently, depending on the message priority. The priority of the message may be changed to urgent so the email reader will respond to the message differently from other messages. For example, when a user opens incoming email, messages 440 are quickly seen that are now HIGH priority, and perhaps a dialog reminding the user of the meeting and listing the messages associated with it. Moreover, user preferences 460 may be used to select an appropriate time to inform the user of a related message. For instance, a user might prefer to be notified only one hour before a meeting for a short message but preferring four hours or a day before “long” messages. Another user preference could set notification delivery times based on a user's location. For example, a user who is working at his or her office desktop computer may only require notification ten minutes before an event, while a user who is working at a more remote location may require notification an hour before the event.

The capabilities incorporated in this embodiment of the present invention also allow for further information to be acquired by the user. The same mechanism can also inform a user as to whether the other members of a meeting invitee list have or have not read messages. This could be advantageous in preparing a user for how much background material will have to be dealt with in the meeting. The same process can also inform users as to the achievement of milestone events in a group project.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A method for automatically alerting a user to electronic communication related to a scheduled event, comprising:
scanning an electronic calendar associated with said user to find said scheduled event;
scanning an electronic message inbox associated with said user to find said electronic communication related to said scheduled event;
determining if said user requires notification of said electronic communication; and
alerting said user of said electronic communication.

2. A method as described in claim 1, wherein said electronic communication is an email message.

3. A method as described in claim 1, wherein said scheduled event is a meeting scheduled in said electronic calendar.

4. A method as described in claim 1, wherein said scheduled event is an event related to a project scheduled in said electronic calendar.

5. A method as described in claim 1, wherein said scanning an electronic message inbox comprises seeking key words in said electronic communication that match said scheduled event.

6. A method as described in claim 1, wherein said determining if said user requires notification comprises submitting said electronic communication to a user-selected rules test.

7. A method as described in claim 6, wherein said user-selected rules comprise user-composed rules.

8. A method as described in claim 6, wherein said user-selected rules comprise scanning a meeting priority table.

9. A method as described in claim 1, wherein said alerting said user comprises highlighting said electronic message with a special visual attribute.

10. A method as described in claim 1 wherein said alerting said user comprises sending said user a wireless communication regarding said electronic message.

11. A system for alerting a recipient of an electronic message to an incoming message associated with a scheduled event, comprising:
a computer network comprising a plurality of work center computers;
electronic communication between said work center computers in said computer network;
an electronic calendar application and database associated with a user in said network;
an electronic mail application comprising electronic messages;
a means for automatically scanning an electronic message sent to said user;
a means for automatically scanning said electronic calendar database, wherein said means for automatically scanning is for finding scheduled events associated with said electronic message; and
a means for notifying said user of said electronic message.

12. A system as described in claim 11, wherein said electronic message is email message.

13. A system as described in claim 11, wherein said electronic calendar application and database are resident in a computer system of said user.

14. A system as described in claim 11, wherein said means for automatically scanning said electronic message is resident in a work center computer.

15. A system as described in claim 11, wherein said means for automatically scanning said electronic calendar is resident in a work center computer.

16. A system as described in claim 11, wherein said means for notifying said user is enabled to contact a pager.

17. A system as described in claim 11, wherein said means for notifying said user is enabled to contact a cellular phone.

18. A system as described in claim 11, further comprising a means for evaluating relative priority of said electronic message by subjecting said electronic message to a set of user-selected rules.

19. A computer-usable medium having computer-readable program code embodied therein for causing a computer system to perform a method for user notification comprising:
scanning a calendar application associated with a user to find a scheduled event;
scanning an electronic message inbox associated with said user to find an electronic communication related to said scheduled event;
determining if said user requires notification of said electronic communication; and
notifying said user of said electronic communication in response to said determining.

20. The computer-usable medium of claim 19, wherein said electronic communication is an email message.

21. The computer-usable medium of claim 19, wherein said scheduled event is a meeting.

22. The computer-usable medium of claim 19, wherein said scheduled event is an event related to a project.

23. The computer-usable medium of claim 20, wherein said scanning an electronic message inbox seeks key words in a subject header of said email message.

24. The computer-usable medium of claim 19, wherein said determining is accomplished by subjecting said electronic communication to a user-selected-rules test.

25. The computer-usable medium of claim 24, wherein said user-selected rules are modified by user preferences.

26. The computer-usable medium of claim 19 wherein said notifying said user comprises displaying said electronic message with a special display attribute.
